(19) United States
(12) Patent Application Publication
(10) Pub. No.: US 2009/0070373 A1
(43) Pub. Date: Mar. 12, 2009

(54) METHOD AND APPARATUS FOR PROCESSING MULTIMEDIA CONTENT AND METADATA

(75) Inventors: Seong-hun JEONG, Suwon-si (KR); Mi-hwa Park, Anyang-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/044,281

(22) Filed: Mar. 7, 2008

(30) Foreign Application Priority Data
Sep. 7, 2007 (KR) 10-2007-0091123

(51) Int. Cl. G06F 17/00

(52) U.S. Cl. 707/104.1; 707/E17.009

(57) ABSTRACT

Provided are a method and apparatus for processing multimedia content and metadata in order to efficiently manage the metadata. The method includes forming an audio/video content file structure comprising a plurality of fundamental units for storing multimedia data and metadata, and adding metadata update related information to each of the fundamental units.

### CROSS-REFERENCE TO RELATED PATENT APPLICATION

This application claims the benefit of Korean Patent Application No. 10-2007-0091123, filed on Sep. 7, 2007, in the Korean Intellectual Property Office, the disclosure of which is incorporated herein in its entirety by reference.

### BACKGROUND OF THE INVENTION

1. Field of the Invention

Methods and apparatuses consistent with the present invention relate to multimedia content reproduction, and more particularly, to processing multimedia content and metadata in order to efficiently manage the metadata.

2. Description of the Related Art

Due to recent growth in the popularity of audio/video (A/V) players, such as portable multimedia players (PMPs) and MP3 players, providing various additional functions, demands of multimedia content are being increased.

A/V players provide A/V content provided by a server (e.g., contents provider) and various additional information and functions using metadata.

Metadata can include information about the A/V content, information regarding an author, rights conditions, use conditions, and information regarding a use history.

For example, metadata of audio data can include a play time, song titles, and names of singers.

Metadata may include more detailed information such as family relationships of singers, information regarding previous albums of the singers, and history information of the singers.

The contents of such metadata vary over time. That is, a plurality of pieces of metadata existing in content initially distributed by a contents provider (CP) corresponds to past information. For example, profiles of actors and actresses and application upgrades constitute past information.

Thus, A/V content players must upgrade metadata via a network, such as the Internet, in order to provide up-to-date information to users.

For example, each of a plurality of A/V content players may always request a CP for new metadata for input multimedia content.

In this case, the CP transmits all or a portion of metadata of content requested by a user to a corresponding A/V content player.

The A/V content player compares metadata stored in a storage medium of the AV content player and the metadata received from the CP. In this case, a metadata comparison method comprises comparing a checksum of each piece of metadata using a message digest algorithm, such as Message Digest Algorithm-5 (MD5), or transmits/receives the entire metadata and compares the entire metadata and the stored metadata.

However, each A/V content player must always connect to the CP in order to update metadata.

Thus, since every A/V content player must check metadata received from the CP one by one, a delay time occurs and a waiting time for reproduction increases. In addition, due to the comparison of existing metadata and new metadata, a burden of the CP for processing metadata increases. In addition, when one of the A/V content players uses the message digest algorithm, an amount of metadata increases, and thus, a burden for processing the metadata increases. In addition, when one of the A/V content players does not use the message digest algorithm, the same metadata must be always retransmitted to or received from the CP, which is inefficient.

### SUMMARY OF THE INVENTION

The present invention provides a method and apparatus for processing multimedia content in order to efficiently update metadata by adding a field for metadata management to the multimedia content.

The present invention also provides a method and apparatus for processing metadata of multimedia content in order to efficiently update metadata using metadata update related information added to the multimedia content.

According to an aspect of the present invention, there is provided a method of processing multimedia content, the method including: forming an A/V content file structure comprising a plurality of fundamental units for storing multimedia data and metadata; and adding metadata update related information to each of the fundamental units for storing multimedia data and metadata.

According to another aspect of the present invention, there is provided a method of processing metadata of content, the method including: checking whether an expiry date of metadata has elapsed by referring to metadata update information added to each of a plurality of fundamental units for storing multimedia data; transmitting a metadata update request to a contents provider every time metadata of which the metadata expiry date has elapsed is extracted; comparing a stored metadata updated value with a metadata updated value received from the contents provider and determining whether corresponding metadata is received; if the metadata is received, updating a last updated value of the metadata.

According to another aspect of the present invention, there is provided an apparatus for processing metadata of content, the apparatus including: a metadata repository in which update related information is added to metadata provided from a content storage medium or a contents provider and stored; a metadata synchronization scheduler generating a metadata update command every time metadata of which a metadata expiry date has elapsed is extracted, by referring to metadata update information added to each of a plurality of units for storing multimedia data in the metadata repository; and a metadata update unit transmitting a metadata update request to the contents provider, receiving corresponding updated metadata from the contents provider, and updating an updated value of the metadata every time the metadata update command is generated by the metadata synchronization scheduler.

According to another aspect of the present invention, there is provided an apparatus for processing multimedia content, the apparatus including: a content input unit inputting a content storage medium; a storage unit storing multimedia data and metadata of the content storage medium; a communication unit bidirectionally communicating with a content server using a wired or wireless method; and a controller transmitting a metadata update request via the communication unit by referring to a metadata update related field added to each of a plurality of fundamental storage units of multimedia content input from the content input unit, receiving updated metadata from a contents provider, and updating corresponding metadata.

According to another aspect of the present invention, there is provided a recording medium including a fundamental data area in which multimedia data and metadata is recorded; and a metadata update related information area which is added to the fundamental data area. The metadata update related information may include a last updated field in which a time when corresponding metadata is updated is recorded; and an expiry field in which an expiry date of the metadata is recorded

### BRIEF DESCRIPTION OF THE DRAWINGS

The above and other aspects of the present invention will become more apparent by describing in detail exemplary embodiments thereof with reference to the attached drawings in which:

FIG. 1 is a schematic view of a multimedia content file structure according to an exemplary embodiment of the present invention;

FIG. 2 is a schematic configuration of a metadata processing system according to an exemplary embodiment of the present invention;

FIG. 3 is a block diagram of an A/V player illustrated in FIG. 2, according to an exemplary embodiment of the present invention;

FIG. 4 is a flowchart illustrating a method of generating a multimedia content file structure, according to an exemplary embodiment of the present invention;

FIG. 5 is a flowchart illustrating a method of processing metadata in an A/V player, according to an exemplary embodiment of the present invention; and

FIG. 6 is a schematic configuration of a metadata processing system according to another exemplary embodiment of the present invention.

### DETAILED DESCRIPTION OF EXEMPLARY EMBODIMENTS OF THE INVENTION

The present invention will be described in detail by explaining exemplary embodiments of the invention with reference to the attached drawings.

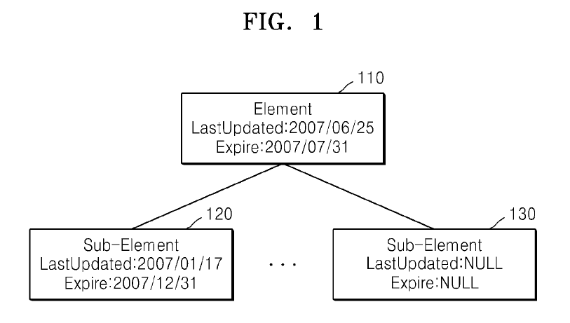

FIG. 1 is a schematic view of a multimedia content file structure according to an exemplary embodiment of the present invention.

Most A/V content file formats are constructed in a tree pattern including elements or objects. Referring to FIG. 1, the multimedia content file structure according to the current exemplary embodiment of the present invention includes an element 110 and a plurality of sub-elements 120, . . . , 130 formed in a tree pattern. In this case, each of the element 110 and the sub-elements 120, . . . , 130 corresponds to a fundamental storage unit for storing data in a storage medium and includes A/V data and metadata.

In the current exemplary embodiment, a metadata update related field is added to each of the element 110 and the sub-elements 120, . . . , 130. The metadata update related field includes a last updated field and an expiry field.

For example, a last updated field in which a metadata update time “Jun. 25, 2007” is recorded and an expiry field in which a metadata expiring date “July 31, 2007” is recorded may be added to the element 110 in the upper layer of the multimedia content file structure.

The last updated field is a field in which a time when corresponding metadata is updated is recorded. When a value of metadata is changed, a last updated field value is changed to a last updated value recorded by a CP. The expiry field is a field in which an expiry date of corresponding metadata is recorded. Even when a value of the metadata is not changed, an expiry field value is always changed to a new value designated by the CP.

The metadata update related field can be recorded in every element unit of an A/V content file structure. However, the metadata update related field does not have to be recorded in every element unit. For example, a metadata update related field value recorded in a certain element may have high priority, and an element in which a metadata update related field value is not recorded assumes a metadata update related field value recorded in an element in an upper layer. For example, as illustrated in FIG. 1, when a metadata update related field value is not recorded in the sub-element 130 (when null data is recorded) in the lower layer, the metadata update related field value of the sub-element 130 assumes a metadata update related field value of the element 110 in the upper layer.

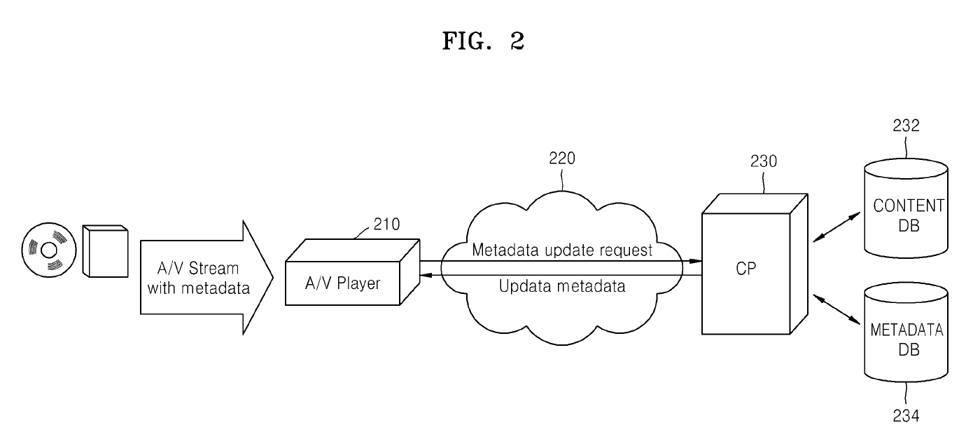

FIG. 2 is a schematic configuration of a metadata processing system according to an exemplary embodiment of the present invention.

Referring to FIG. 2, the metadata processing system according to the current exemplary embodiment of the present invention includes an A/V player 210, a wired/wireless network 220 and a CP 230.

The A/V player 210 and the CP 230 perform bi-directional communication by which a metadata update request is transmitted and updated metadata is received via the wired/wireless network 220 in a wired/wireless manner.

The A/V player 210 receives an A/V stream stored in a multimedia storage medium, such as an optical disk or a flash memory. The A/V stream includes metadata. The A/V stream includes fundamental storage units (elements or objects) in which multimedia data and metadata are stored. The A/V stream also includes a metadata update related field in each of the storage units.

The metadata update related field can be previously stored in the multimedia storage medium or added on an element or object basis by the A/V player 210.

The A/V player 210 transmits a specific metadata update request to the CP 230 via the wired/wireless network 220 every time metadata of which an expiry date has elapsed is extracted by referring to a metadata update related field added on an element basis and receives updated metadata from the CP 230. The received new metadata is recorded in a storage space of the A/V content title or the A/V player 210.

According to another exemplary embodiment, the A/V player 210 stores only the metadata transmitted from the A/V content title or the CP 230 in a nonvolatile storage device such as a hard disk drive (HDD) or a flash memory. In this case, the metadata is periodically updated to new metadata using a metadata update method according to an exemplary embodiment of the present invention.

Referring to FIG. 2, the CP 230 is connected to a content database (DB) 232 and a metadata DB 234. Thus, the CP 230 transmits updated metadata to the A/V player 210 by comparing update information of specific metadata with update information of metadata stored in the metadata DB 234 according to the specific metadata update request received from the A/V player 210.

In addition, if an expiry date of corresponding metadata has elapsed, the CP 230 periodically transmits a command of transmitting a metadata upgrade request signal to the A/V player 210.

In addition, the CP 230 designates a new expiry value for updated metadata.

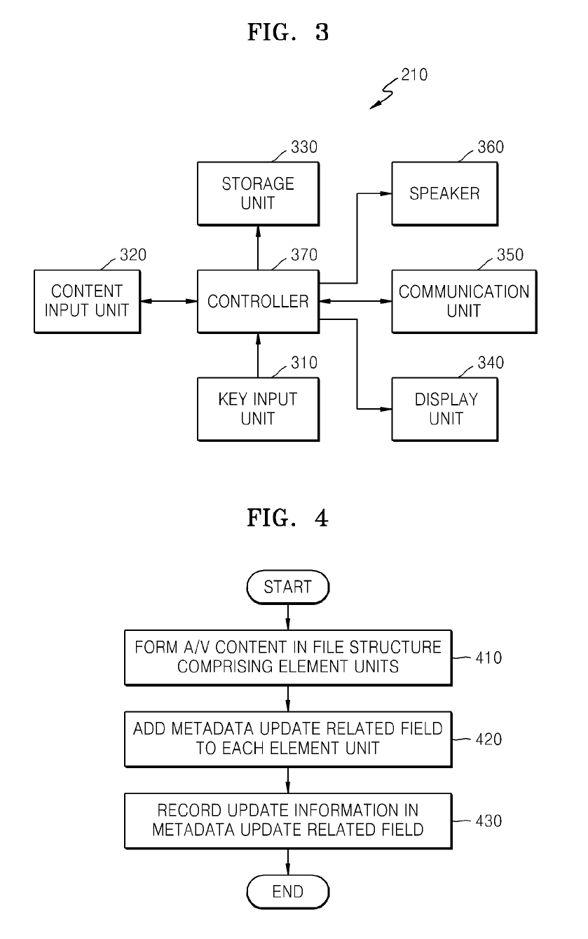

FIG. 3 is a block diagram of the A/V player 210 illustrated in FIG. 2, according to an exemplary embodiment of the present invention.

Referring to FIG. 3, the A/V player 210 according to the current exemplary embodiment of the present invention includes a key input unit 310, a content input unit 320, a storage unit 330, a display unit 340, a communication unit 350, a speaker 360, and a controller 370.

The key input unit 310 receives a user command using a key module having a plurality of keys or a touch screen.

The content input unit 320 receives content in an A/V stream type, which is stored in a multimedia storage medium, such as an optical disk or a flash memory.

The storage unit 330 can be a flash memory or an HDD and stores a control program driving the controller 370 and multimedia data and metadata of A/V content.

The display unit 340 displays various kinds of information in a pop-up or graphic type in response to an operation of the controller 370.

The communication unit 350 includes a wired/wireless communication interface and performs bi-directional communication with the CP 230 via a network in a wired/wireless manner.

The speaker 360 reproduces an audio signal output from the storage unit 330 or the controller 370 to output sound.

When specific content is input from the content input unit 320, the controller 370 transmits a metadata update request to the CP 230 by referring to a metadata update related field added to the content file, receives updated metadata from the CP 230, and stores the updated metadata in the storage unit 330.

FIG. 4 is a flowchart illustrating a method of generating a multimedia content file format, according to an exemplary embodiment of the present invention.

Referring to FIG. 4, A/V content is formed in a file structure including a plurality of element (or object) units corresponding to fundamental storage units in operation 410.

A metadata update related field is added to each of the element units in operation 420.

An updated time and an expiry date of corresponding metadata are recorded in the metadata update related field in operation 430.

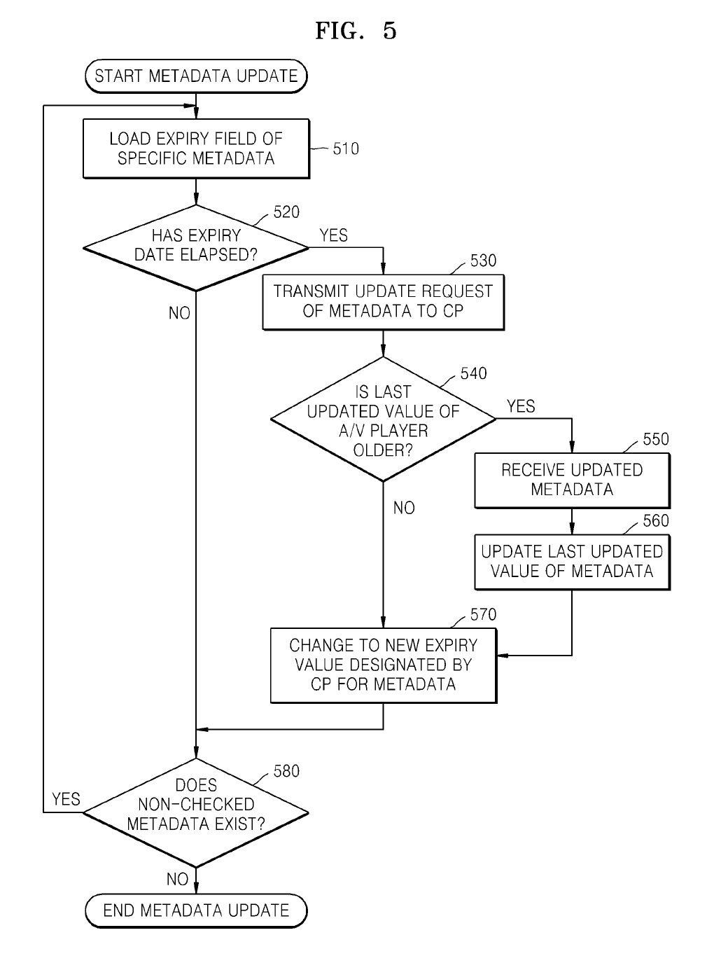

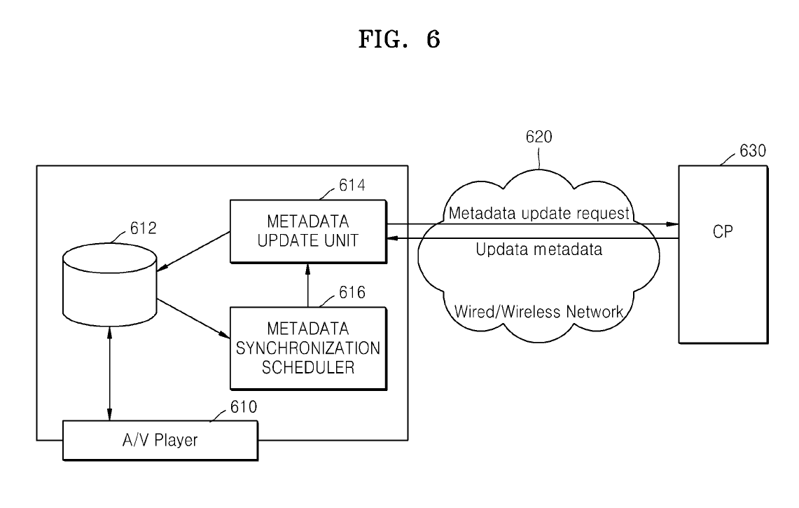

FIG. 5 is a flowchart illustrating a method of processing metadata in an A/V player, according to an exemplary embodiment of the present invention.

Referring to FIG. 5, when A/V content is input, an expiry field of metadata of the A/V content is loaded in operation 510.

It is determined based on expiry information recorded in the expiry field in operation 520 whether an expiry date of the metadata has elapsed.

If it is determined that the expiry date of the metadata has elapsed, an update request of the metadata is transmitted to CP in operation 530. According to another exemplary embodiment, if it is determined that the expiry date of the metadata has elapsed, a metadata upgrade request can be automatically transmitted to the CP.

An updated value of the metadata is compared with an updated value of metadata received from the CP, and it is determined in operation 540 whether new metadata is received. According to another exemplary embodiment, the process of comparing metadata updated values may be performed by the CP.

If the metadata updated value of the A/V player is updated in the past in comparison to the metadata updated value of the CP server, the A/V player requests the CP for updated metadata. Thus, the A/V player receives updated metadata for the metadata in operation 550.

A last updated value of the metadata is updated to a new updated value of the updated metadata provided by the CP in operation 560. Thus, the new updated value is recorded in a last updated field of the metadata.

If the metadata updated value of the A/V player is updated not in the past in comparison to the metadata updated value of the CP, or if the last updated value of the metadata has been updated, an expiry value of the metadata is updated to a new expiry value designated by the CP in operation 570. Thus, a new updated value is recorded in the expiry field of the metadata.

It is determined in operation 580 whether non-checked metadata exists. If it is determined in operation 580 that non-checked metadata exists, operations 510 to 570 are repeated, and if it is determined in operation 580 that non-checked metadata does not exist, this metadata updating process ends.

FIG. 6 is a schematic configuration of a metadata processing system according to another exemplary embodiment of the present invention.

Referring to FIG. 6, the metadata processing system according to the current exemplary embodiment of the present invention includes an A/V player 610, a wired/wireless network 620, and a CP 630.

The A/V player 610 and the CP 630 perform bi-directional communication via the wired/wireless network 620 in a wired/wireless manner.

The A/V player 610 further includes a metadata repository 612, a metadata update unit 614, and a metadata synchronization scheduler 616.

The metadata repository 612 is a nonvolatile storage space, such as an HDD or a flash memory, and stores metadata of an A/V content title or the CP 630, which is collected by the A/V player 610. Metadata update related information, such as a last updated field and an expiry field, is added to the metadata.

The metadata synchronization scheduler 616 determines by referring to the metadata update related information stored in the metadata repository 612 whether metadata of which an expiry date has elapsed exists and generates a metadata update processing command every time metadata of which an expiry date has elapsed is extracted.

Every time the metadata update processing command is received from the metadata synchronization scheduler 616, the metadata update unit 614 transmits a metadata update request to the CP 630, receives updated metadata according to comparison of a stored metadata updated value and a received metadata updated value, and updates an updated value of the metadata. In addition, the metadata update unit 614 changes an expiry value of the updated metadata received from the CP 630 to an expiry value designated by the CP 630.

Thus, when a user reproduces content, the metadata repository 612 provides stored metadata to the A/V player 610.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion.

As described above, according to the exemplary embodiments of the present invention, by adding a field for metadata management to multimedia content, an A/V content player can accurately determine a metadata update time. Thus, the A/V content player can reduce a delay time required to process metadata. Accordingly, a user can reduce a waiting time for content reproduction.

In addition, a CP server can reduce a burden for processing metadata transmission by removing unnecessary network access to the A/V content player and reduce the occurrence of unnecessary network traffic.

In addition, the A/V content player can be modified to various applications by using a metadata repository.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of processing multimedia content, the method comprising:
forming an audio/video (A/V) content file structure comprising a plurality of fundamental units for storing multimedia data and metadata; and
adding metadata update related information to each of the plurality of fundamental units.

2. The method of claim 1, wherein the plurality of fundamental units comprise element or object units.

3. The method of claim 1, wherein the metadata update related information comprises:
a last updated field in which a time when corresponding metadata is updated is recorded; and
an expiry field in which an expiry date of the metadata is recorded.

4. The method of claim 3, wherein a value of the last updated field is changed to a last updated value recorded in a contents provider when a value of the metadata is changed.

5. The method of claim 3, wherein a value of the expiry field is changed to a new value designated by a contents provider even when a value of the metadata is not changed.

6. The method of claim 1, wherein, if a metadata updated value is not recorded in a specific fundamental unit, the metadata updated value of the specific fundamental unit assumes a metadata updated value of a fundamental unit in a layer above a layer comprising the specific fundamental unit.

7. A method of processing metadata of content, the method comprising:
checking whether an expiry date of metadata has elapsed by referring to metadata update information added to each of a plurality of fundamental units for storing multimedia data;
transmitting a metadata update request to a contents provider each time metadata of which the metadata expiry date has elapsed is extracted;
comparing a stored metadata updated value with a metadata updated value received from the contents provider;
determining whether corresponding metadata is received based a result of the comparing;
if it is determined the metadata is received, updating a last updated value of the metadata.

8. The method of claim 7, further comprising, if the expiry date of the metadata has elapsed, transmitting the metadata update request to the contents provider.

9. The method of claim 7, wherein each time the expiry date of the metadata has elapsed, the expiry date is updated to a metadata expiry value designated by the contents provider for the metadata.

10. The method of claim 7, wherein the receiving the metadata comprises receiving updated metadata of the metadata if the last updated value of the metadata is updated in the past in comparison to an updated value of the contents provider.

11. An apparatus for processing metadata of content, the apparatus comprising:
a metadata repository in which update related information is added to metadata provided from a content storage medium or a contents provider and stored;
a metadata synchronization scheduler which generates a metadata update command each time metadata of which a metadata expiry date has elapsed is extracted, by referring to metadata update information added to each of a plurality of units for storing multimedia data in the metadata repository; and
a metadata update unit which transmits a metadata update request to the contents provider, receives corresponding updated metadata from the contents provider, and updates an updated value of the metadata each time the metadata update command is generated by the metadata synchronization scheduler.

12. An apparatus for processing multimedia content, the apparatus comprising:
a content input unit which inputs a content storage medium;
a storage unit in which multimedia data and metadata of the content storage medium are stored;
a communication unit which bidirectionally communicates with a content server; and
a controller which transmits a metadata update request via the communication unit by referring to a metadata update related field added to each of a plurality of fundamental storage units of multimedia content input from the content input unit, receives updated metadata from a content provider, and updates corresponding metadata.

13. A computer readable recording medium storing a computer readable program for executing a method of processing multimedia content, the method comprising:
forming an audio/video content file structure comprising a plurality of fundamental units for storing multimedia data and metadata; and
adding metadata update related information to each of the plurality of fundamental units.

14. A recording medium comprising:
a fundamental data area in which multimedia data and metadata is recorded; and
a metadata update related information area which is added to the fundamental data area.

15. The recording medium of claim 14, wherein the metadata update related information comprises:
a last updated field in which a time when corresponding metadata is updated is recorded; and
an expiry field in which an expiry date of the metadata is recorded.
